(19) United States
(12) Patent Application Publication
(10) Pub. No.: US 2019/0266111 A1
(43) Pub. Date: Aug. 29, 2019

(54) METHOD AND APPARATUS FOR HIGH SPEED DATA PROCESSING

(71) Applicant: Goke US Research Laboratory, Santa Clara, CA (US)

(72) Inventors: Engling Yeo, San Jose, CA (US); Chandra Varanasi, Santa Clara, CA (US)

(21) Appl. No.: 15/907,101

(22) Filed: Feb. 27, 2018

(51) Int. Cl. G06F 13/16; G06F 13/42

(52) U.S. Cl. CPC G06F 13/1668; G06F 2213/0026; G06F 13/4282

(57) ABSTRACT

A system, method and apparatus for performing high data throughput computations is disclosed. An I/O device, such as a solid state hard drive (SSD), is configured with programmable circuitry, in addition to traditional data storage and retrieval components. A host processor configures the programmable circuitry to perform one of any number of high data throughput computations using the same data storage and retrieval protocol used to store data on the I/O device.

### BACKGROUND

### I. Field of Use

The present invention relates to the field of digital data processing and more specifically to high speed data processing of large volumes of data.

### II. Description of the Related Art

The advent of low cost IP cameras has enabled security companies to capture large volumes of high-resolution video. In cost-conscious systems, video recording is started only after a trigger event is detected, such as detection of movement by a motion sensor. This reduces the amount of recorded data (e.g. 30 seconds after each trigger event) and acts as a filter so that the captured video clips may be reviewed manually by a human being. In this way, an entire day of surveillance data may be manually reviewed.

In other applications, such as constant surveillance of human or vehicular traffic, it is difficult to set up trigger rules. Therefore, large volumes of video data are stored in order to capture every second of activity. The video data may then be reviewed to determine whether a particular event has occurred, such as the presence of a particular suspect or other person of interest. The amount of data is often excessive, making it unreasonable for human review. In these cases, the video data may be reviewed by a machine, using advanced image-recognition algorithms, as opposed to a human reviewer.

A traditional computer system comprises a host processor with a number of storage I/O devices attached through a PCIe backbone. Repeatedly retrieving large amounts of video data from the storage I/O devices can create a bottleneck at the I/O interfaces. For example, in order to spend under 5 minutes searching for a particular event over 24 hours of surveillance data, a nominal 30 frame-per-sec system with a 5 Megapixel camera will require 1.4 GBps bandwidth with MPEG4-compressed data or 70 GBps bandwidth for uncompressed video.

The bandwidth requirements quickly increase when attempting to evaluate surveillance from a number of sources, such as a of synchronized video cameras mounted to survey a location at multiple angles. Use of multiple cameras can improve the rate of detection and lower the rate of false alarms.

PCIe is an evolving standard. Currently, version 4.0 is available, having a throughput of up to 31.5 Gbps using 16 lanes. However, this technology is very expensive and would require legacy computing systems to be replaced at an enormous cost.

Therefore, it would be desirable to process large volumes of data without the bottleneck caused by a host system I/O interface.

### SUMMARY

The embodiments herein describe methods and apparatus for performing high data throughput computations using an I/O device coupled to a host processor. In one embodiment, a configurable I/O device is described, comprising a controller for performing a first function related to the I/O device in response to receiving instructions from a host processor over a data bus in accordance with a data storage and retrieval protocol, a memory coupled to the controller for storing data received from the controller, and programmable circuitry coupled to the controller for performing a second function unrelated to data storage and retrieval in response to second instructions received by the controller from the host processor over the data bus in accordance with the data storage and retrieval protocol.

In another embodiment, a computer system is described for providing high-throughput data processing, comprising a host processor, and an I/O device electronically coupled to the host processor by a data bus, the I/O device comprising a controller for performing a first function related to the I/O device in response to receiving instructions from a host processor over the data bus in accordance with a data storage and retrieval protocol, and programmable circuitry for performing a function unrelated to data storage and retrieval in response to second instructions received by the controller from the host processor over the data bus in accordance with the data storage and retrieval protocol.

In yet another embodiment, a method is described for performing high data throughput computations, comprising storing data in a memory of an I/O device by a host processor using a data storage and retrieval protocol, the I/O device coupled to the host processor via a data bus, configuring programmable circuitry located within the I/O device by the host processor using the data storage and retrieval protocol, and causing, by the host processor, the programmable circuitry to initiate the high data throughput computations using the data storage and retrieval protocol.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a functional block diagram of one embodiment of a host computer using the inventive concepts described herein;

FIG. 2 illustrates a functional block diagram of one embodiment of an I/O device shown in FIG. 1;

FIG. 3 illustrates a functional block diagram of another embodiment of the computer system shown in FIG. 1, showing a number of internal I/O devices and an external I/O device; and

FIG. 4 is a flow diagram illustrating one embodiment of a method performed by a host processor and an I/O device as shown in FIGS. 1 and 2 to configure and control high-throughput data processing by the I/O device.

### DETAILED DESCRIPTION

Methods and apparatus are provided for evaluating large volumes of data at high speed, without sacrificing processing capabilities of a host processor. High speed processing is performed by an I/O device coupled to a host processor in a computer system, rather than the host processor itself, as is typically found in the art. This avoids bandwidth constriction limitations with traditional PC bus architectures, freeing up host processor resources. This method is suitable for a scale-out architecture in which data is stored across multiple I/O devices, each comprising dedicated, configurable processing hardware to perform high-speed processing.

Consider an SSD drive comprising a 16-Channel ONFI controller, with an 800 MBps ONFI interface. The controller is able to retrieve MPEG4-compressed data at 12 GBps from a number of flash chips that constitute the SSD. Reconfigurable programmable circuitry is added to the controller, dedicated to performing computational-intensive operations, such as automated review of video data stored by the flash chips. This arrangement can allow a video pattern-matching algorithm executed by the programmable circuitry to process up to 8 video streams simultaneously in just five minutes for every 24 hours of video footage examined, for example.

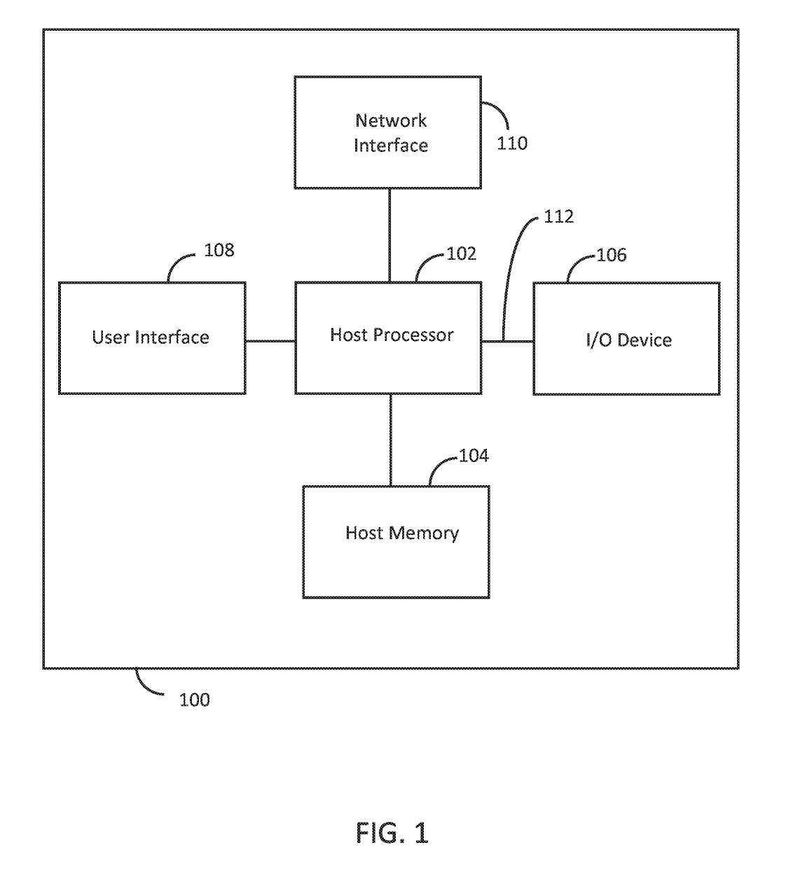

FIG. 1 illustrates a functional block diagram of one embodiment of a host computer 100 using the inventive concepts described herein. Shown is host computer 100, comprising host processor 102, host memory 104, I/O device 106, user interface 108, and network interface 110. Host computer 102 and I/O device 106 are electronically coupled via data bus 112. I/O device typically comprises a connector that plugs into an expansion port on a motherboard of host computer 100.

Host computer 100 may comprise a personal computer, laptop, or server used to perform a variety of tasks such as word processing, web browsing, email, and certain specialized tasks, such as automated review of digitized video footage, cryptocurrency mining, or speech recognition, among many others. In one embodiment, host computer 100 is used to analyze data provided by I/O device 106 at very high data throughput rates. For example, I/O device 106 may comprise a large-capacity SSD for storing large video files generated by an outdoor digital video camera monitoring a location of interest, such as an airport entrance. The video camera may provide a high-resolution video stream to the I/O device 106 twenty-four hours per day, seven days per week over conventional communication technology, such as Ethernet wiring or a Wi-Fi network. The digitized video may be received by host computer 100 via network interface 110 from the Internet and stored on I/O device 106 by host processor 102 for later review to search the video, for example, for a person or thing of interest, such as a suspect or a vehicle involved in a crime. In order to quickly review the video data, an image-matching algorithm may executed by programmable circuitry residing in I/O device 106 in order to eliminate a data throughput bottleneck that normally result if the image-matching algorithm were to be executed by host processor 102.

Processor 102 is configured to provide general operation of host computer 100 by executing processor-executable instructions stored in memory 104, for example, executable computer code. Processor 102 typically comprises a general purpose microprocessor or microcontroller manufactured by Intel Corporation of Santa Clara, Calif. or Advanced Micro Devices of Sunnyvale, Calif., selected based on computational speed, cost and other factors.

Memory 104 comprises one or more non-transitory information storage devices, such as RAM, ROM, EEPROM, UVPROM, flash memory, SD memory, XD memory, or other type of electronic, optical, or mechanical memory device. Memory 104 is used to store processor-executable instructions for operation of host computer 100. It should be understood that in some embodiments, a portion of memory 104 may be embedded into processor 102 and, further, that memory 104 excludes media for propagating signals.

Data bus 112 comprises a high-bandwidth interface between host processor 102 and peripheral devices such as I/O device 106. In one embodiment, data bus 112 conforms to the well-known Peripheral Component Interconnect Express, or PCIe, standard. PCIe is a high-speed serial computer expansion bus standard designed to replace older PCI, PCI-X, and AGP bus standards. Data bus 112 is configured to allow high-speed data transfer between host processor 102 and I/O device 106, such as data storage and retrieval, but may also transport configuration information, operational instructions and related parameters for processing by I/O device 106 as described in greater detail later herein.

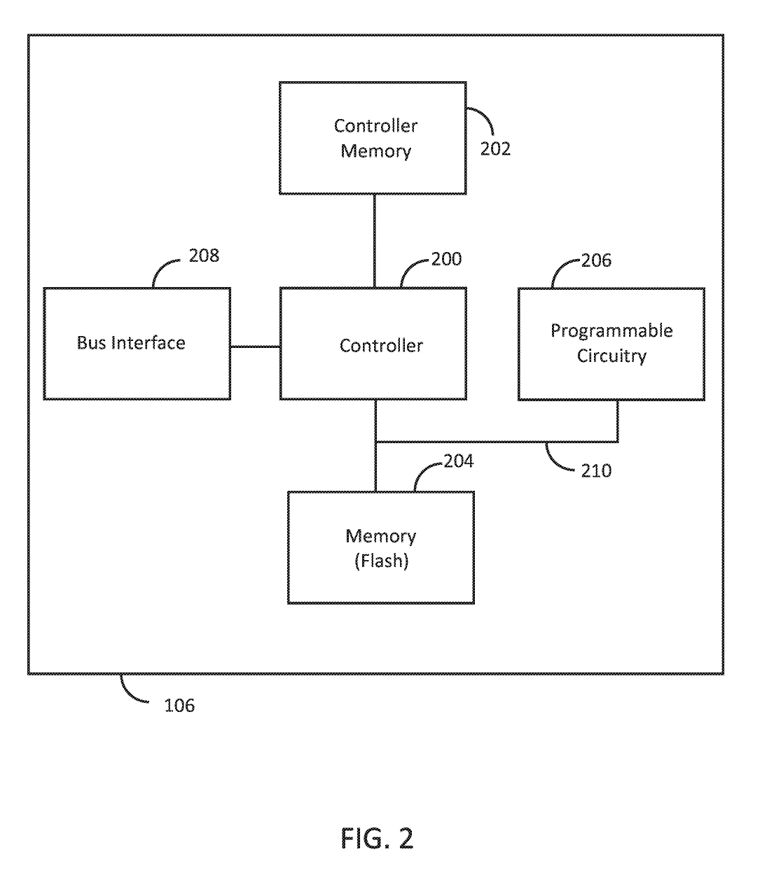

I/O device 106 comprises one or more internal or external peripheral devices coupled to processor 102 via data bus 112. As shown in FIG. 2. I/O device 106 comprises a high-capacity SSD, comprising a controller 200 and a memory 204, however in other embodiments, I/O device might comprise a video card, a sound card or some other peripheral device. Host processor 102 communicates with controller 200 via bus 112 and bus interface 208, which comprises circuitry well known in the art for providing a data interface to I/O device 106 (in other embodiments, bus interface 208 is incorporated into processor 200). The primary function of I/O device 106 in this embodiment is high-speed storage and retrieval of data provided by host processor 102 over data bus 112 using one of any number of high-speed data transfer protocols. In one embodiment, the well-known NVMe data storage interface is used, which defines both a register-level interface and a command protocol used by host processor 102 to communicate with NVMe-compliant devices. For example, controller I/O device 106 may comprise a 16-Channel ONFI-compliant NAND SSD with an 800 MBps NVMe interface. Utilizing all 16 channels, data may be stored or retrieved from memory 204 at a throughput of over 12 GBps.

Memory 202 comprises one or more non-transitory information storage devices, such as RAM, ROM, EEPROM, flash memory, SD memory, XD memory, or other type of electronic, optical, or mechanical memory device. Memory 202 is used to store processor-executable instructions for operation of controller 200. It should be understood that in some embodiments, memory 202 is incorporated into controller 200 and, further, that memory 202 excludes media for propagating signals.

Memory 204 comprises one or more non-transitory information storage devices, such as RAM memory, flash memory, SD memory, XD memory, or other type of electronic, optical, or mechanical memory device, used to store data from host processor 102. In a typical SSD, memory 204 comprises a number of NAND flash memory chips, arranged in a series of banks and channels to provide up to multiple terabytes of data. Memory 204 excludes media for propagating signals. Memory 204 is electronically coupled to controller 200 via a number of data and control lines, shown as bus 210 in FIG. 2. For example, bus 210 may comprise eight bidirectional I/O data lines, a write enable and a read enable, among others.

Programmable circuitry 206 comprises any programmable integrated circuit, such as an embedded FPGA, embedded video processor, a tensor processor, or the like, which typically comprise a large quantity of configurable logic gate arrays, one or more processors. I/O logic, and one or more memory devices. An embedded video processor is an IP for a processor targeted for image processing algorithms. The concept is similar to a CPU core IP such as an ARM R5, except that processing elements mostly resemble a matrix of convolutional neural networks (CNN) and digital signal processors. Like an embedded CPU or FPGA, it offers configurability to implement various image processing algorithms. Programmable circuitry 206 may be configured by controller 200 as instructed by host processor 104 over data bus 112. This is accomplished by host processor 104 using a high-speed data protocol, normally used to store and retrieve data with I/O device 106, to program and control operation of programmable circuitry 206, as will be described in greater detail later herein. Programmable circuitry 206 may be coupled to controller 200 via bus 210, connected to the same data and control lines used by controller 200 to store and retrieve data in memory 204, as programmable circuitry 206 typically comprises a number of bidirectional I/O data lines, a write enable and a read enable, among others. It should be understood that in other embodiments, programmable circuitry could be incorporated into controller 200. In these embodiments, programmable circuitry 206 may still utilize the same data and control lines used to store and retrieve data from memory 204.

A traditional I/O device, such as a SSD, typically serves one function, to store and retrieve data. However, I/O device 106 performs at least one other, unrelated function, performed by programmable circuitry 206. For example, programmable circuitry 206 may be configured by host processor 104 (via controller 200) to perform video data pattern recognition on video data stored in memory 204. In this way, large volumes of data from memory 2014 may be processed locally on I/O device 106, eliminating bottlenecks that would otherwise occur if processing were to be performed by host processor 104, due to the bandwidth constraints of data bus 112. For example, a robust PCEi data bus, v.3.x, having 16 lanes, is bandwidth limited to about 16 GBps. Thus, I/o device 106 provides both high-speed data storage functionality, as well as computational functionality to operate on data that is stored in memory 204.

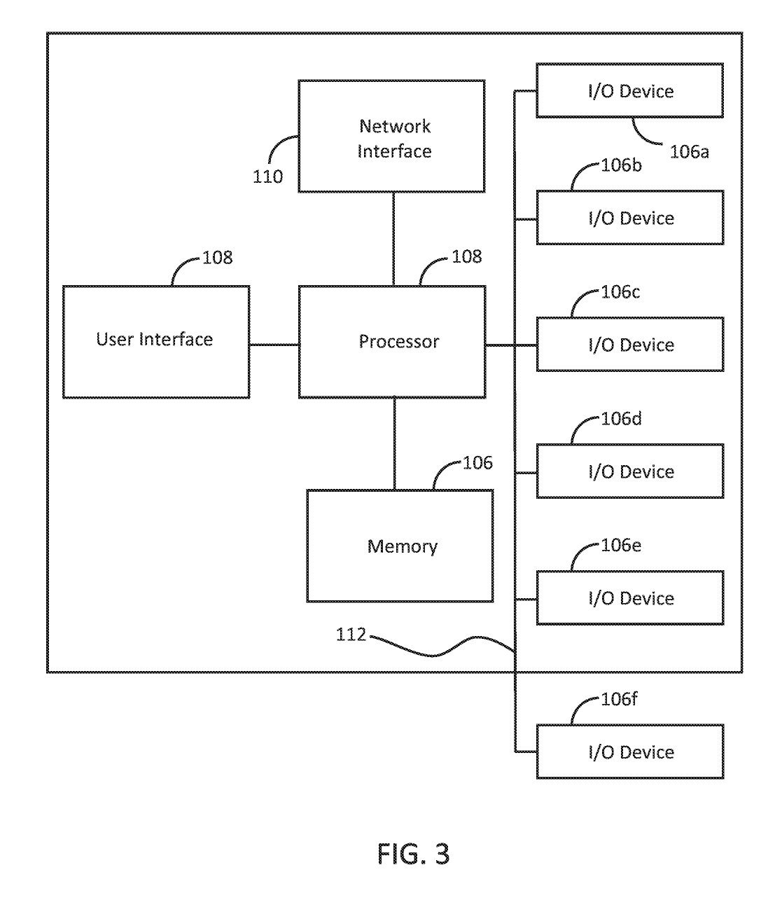

FIG. 3 is another embodiment of computer system 100, showing five internal I/O devices 106a-106e, each mechanically coupled to a motherboard of computer system 100 (not shown) and electrically coupled to host processor 102 via data bus 112. Additionally, I/O device 106f is externally coupled to data bus 112 via a cable typically comprising a number of power, ground and signal wires and having a connector on each end that interfaces to the motherboard and an external connector on I/O device 106f (not shown). In this embodiment, each of the I/O devices stores video data from a respective digital video camera, each of the cameras monitoring a location of interest at different pointing angles and/or distances. The video data may be provided to computer system 100 over the Internet, where it is received by network interface 110 and provided to processor 102, where it is stored in one or more of the I/O devices. In this embodiment, video data from each of the cameras may be processed by a respective I/O device in parallel. Results from each of the I/O devices may be provided to host processor 102, where data obtained from the I/O devices may be correlated to improve the rate of detection and lower the rate of false alarms.

For example, in one embodiment, while comparing a digital image to multiple video feeds, each feed stored on a particular I/O device, host processor 102 may receive an indication from one of the I/O devices of a match at a point in time in one of the video streams, but no such match from the other I/O devices. In this case, host processor 102 may send a command to each of the I/O devices to retrieve video information stored by the respective I/O devices around the time that the particular I/O device identified a match. In response, each I/O device may provide a limited amount of video data. i.e., a video clip, to host processor 102, and host processor 102 may present them to a user via user interface 108.

In another example, a hierarchical search of images/video from each of the I/O devices may be conducted. In this example, host processor 102 may load a particular image matching algorithm to each I/O device using parameters that cause the image matching algorithm to analyze images/video at a coarse level of detail in order to speed up the processing time. Host processor 102 may receive one or more indications from the I/O devices of a match, and a time frame when the match occurred, in which case host processor 102 may direct one or more of the I/O devices to conduct another analysis of the stored images/video using a higher level of image detail and/or at or around the time of interest provided by the reporting I/O device. This process may be repeated, with one or more subsequent analyses performed using images of greater detail and the results provided to a user via user interface 108. In one embodiment, one of the parameters is a frame rate at which to analyze digital video, where coarse processing of the video comprises analyzing the video at a relatively slow frame rate, i.e., processing only 10 frames per second of an available 30 frames per second video, whereas fine processing of the video comprises analyzing the video at the available 30 frames per second.

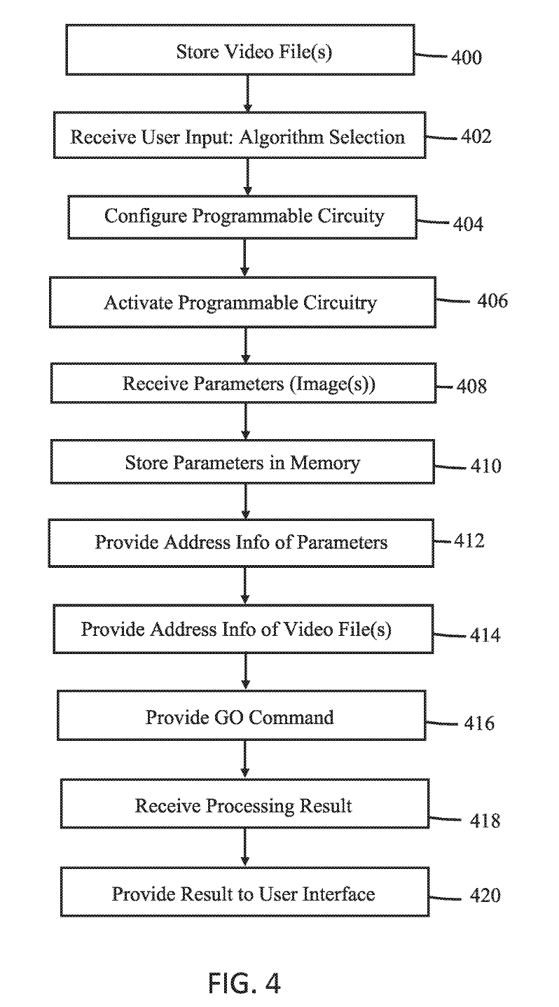

FIG. 4 is a flow diagram illustrating one embodiment of a method performed by host processor 102 and I/O device 106 to configure and control high-throughput data processing by I/O device 106 using data stored by I/O device 106. The method is implemented by host processor 102 and controller 200, executing processor-executable instructions stored in memory 104 and memory 202, respectively. It should be understood that in some embodiments, not all of the steps shown in FIG. 4 are performed and that the order in which the steps are carried out may be different in other embodiments. It should be further understood that some minor method steps have been omitted for purposes of clarity. Finally, it should be understood that although the method steps below discuss the inventive concepts herein as applied to a video surveillance application, in other embodiments, the same concepts can be applied to other applications without departing from the scope of the invention as defined by the appended claims.

In general, the method comprises a) configuration of programmable circuitry 206 by host processor 102 and controller 200 to perform a desired algorithm, b) providing parameters to controller 200 for use with the algorithm, c) performance of the algorithm by programmable circuitry 206, and d) providing results of the algorithm back to host processor 102.

The method is described in reference to use of the well-known NVM Express protocol (NVMe) over a computer's PCIe bus, which allows host processor 102 to communicate with I/O device 106, in this example, an external SSD configured for a primary function of data storage and retrieval and a secondary function of performing image processing.

NVMe is a storage interface specification for Solid State Drives (SSDs) on a PCIe bus. The latest version of the NVMe specification can be found at www.nvmexpress.org, presently version 1.3, dated May 1, 2017, and is incorporated by reference in its entirety herein. Instructions for data storage and retrieval are provided by host processor 102 to controller 200 over data bus 112 in conformance with the NVMe protocol, and configuration, command and control instructions for programmable circuitry 206 are provided by processor 102 using “vendor specific” commands under the NVMe protocol. The NVMe specification allows for these custom, user-defined “vendor specific” commands, shown in FIG. 12 of the NVMe specification and reprinted below, and configuration and control of programmable circuitry 206 is performed using several vendor-specific commands.

Command Format - Admin and NVM Vendor Specific Commands

| Bytes | Description |
|---|---|
| 03:00 | Command Dword 0 (CDW0): This field is common to all commands and is defined in FIG. 10. |
| 07:04 | Namespace Identifier (NSID): This field indicates the namespace ID that this command applies |
| | to. If the namespace ID is not used for the command, then this field shall be cleared to 0h. Setting |
| | this value to FFFFFFFFh causes the command to be applied to all namespaces attached to this |
| | controller, unless otherwise specified. |
| | The behavior of a controller in response to an inactive namespace ID for a vendor specific |
| | command is vendor specific. Specifying an invalid namespace ID in a command that uses the |
| | namespace ID shall cause the controller to abort the command with status Invalid Namespace or |
| | Format, unless otherwise specified. |
| 15:08 | Reserved |
| 39:16 | Refer to FIG. 11 for the definition of these fields. |
| 43:40 | Number of Dwords in Data Transfer (NDT): This field indicates the number of Dwords in the |
| | data transfer. |
| 47:44 | Number of Dwords in Metadata Transfer (NDM): This field indicates the number of Dwords in |
| | the metadata transfer. |
| 51:48 | Command Dword 12 (CDW12): This field is command specific Dword 12. |
| 55:52 | Command Dword 13 (CDW13): This field is command specific Dword 13. |
| 59:56 | Command Dword 14 (CDW14): This field is command specific Dword 14. |
| 63:60 | Command Dword 15 (CDW15): This field is command specific Dword 15. |

In one embodiment, each vendor specific command consists of 16 Dwords, where each Dword is 4-bytes long. (so, the command itself is 64-bytes long.) The contents of the first ten Dwords in the command are pre-defined fields. The next two Dwords (Dword 10 and Dword 11) describe the number of Dwords in the data and the metadata being transferred. The last four Dwords in the command are used to provide task-specific instructions from host processor 102 to controller 200, such as to configure programmable circuitry 206 to perform a particular function and to provide programmable circuitry 206 with information in order for programmable circuitry to perform the function.

At block 400, host processor 102 may begin storing large amounts of data in I/O device 106, using standardized NVMe storage commands. Data may comprise one or more digitized video or audio streams, for example.

At block 402, host computer 102 may receive input from a user via user interface 108, selecting one of several algorithms available to review video data stored in I/O device 106. Host memory 104 may store several image-processing algorithms, each one possessing different video processing characteristics for selection by the user, such as speed or accuracy. In another embodiment, the user may select an algorithm online and download it to host computer 100 for storage in I/O device 106.

At block 404, host processor 102 provides instructions to controller 200, using custom vendor specific commands, for controller 200 to configure programmable circuitry 206 in accordance with a particular video processing algorithm. The algorithm may evaluate the video data stored in memory 204 to determine whether a person or thing of interest has been recorded, such as a fugitive, a kidnapping victim, a license plate, a vehicle, etc. In general, processing comprises almost any data analysis requiring large volumes of data, such as image or video analysis, speech recognition, speech interpretation, facial recognition, etc.

Configuring programmable circuitry 206 typically comprises providing a bitfile to controller 200, where controller 200 than configures programmable circuitry 206 to perform the selected algorithm. In the case where programmable circuitry 120 comprises an FPGA, the bitfile comprises configuration information to manipulate internal link sets of the FPGA. In one embodiment, customized administrative commands are used to provide the bitfile from memory 204 to programmable circuitry 206 via controller 200 in accordance with custom vender specific commands in accordance with the NVMe protocol. As an example, the following table summarizes two, custom vendor specific commands given by host processor 102 to controller 200 for controller 200 to provide a bitfile from memory 204 to programmable circuitry 206 utilizing the NVMe protocol:

| Opcode by Field | | | | | | |
|---|---|---|---|---|---|---|
| (07) | | (01:00) | | | Namespace | |
| Generic | (06:02) | Data | Combined | Optional/ | Identifier | |
| Command | Function | Transfer | Opcode | Mandatory | Used | Command |
| 1b | 001 00b | 00b | 90h | M | No | FPGA Bitfile Commit |
| 1b | 001 00b | 01b | 91h | M | No | FPGA Bitfile Download |

In this example, an FPGA Bitfile Download command of 91h is defined to instruct controller 200 to retrieve all or a portion of a bitfile stored in memory 204 and to configure programmable circuitry 206 in accordance with the bitfile, and the FPGA Bitfile Commit command of 90h causes controller 200 to activate the configuration.

NVMe is based on a paired Submission and Completion Queue mechanism. Commands are placed by host processor 102 into a Submission Queue stored in either host memory 104 or memory 204. Completions are placed into an associated Completion Queue also stored in either host memory 104 or memory 204. Multiple Submission Queues may utilize the same Completion Queue. Submission and Completion Queues are allocated by host processor 102 in memory 104 and/or memory 204. The FPGA Bitfile Download command is submitted to an Admin Submission Queue and may be submitted while other commands are pending in the Admin or I/O Submission Queues. The Admin Submission Queue (and associated Completion Queue) exist for the purpose of management and control (e.g., creation and deletion of I/O Submission and Completion Queues, aborting commands, etc.).

In one embodiment, an FPGA Bitfile Download command is defined that uses a Data Pointer, Command Dword 10 and Command Dword 11, as shown below:

FPGA Bitfile Download - Data Pointer

| Bit | Description |
|---|---|
| 127:00 | Data Pointer (DPTR): This field specifies the location in |
| | memory 204 where data should be transferred from. Refer |
| | to FIG. 11 of NVMe 1.3 Specifications for the definition |
| | of this field. |

Firmware Image Download - Command Dword 10

| Bit | Description |
|---|---|
| 31:00 | Number of Dwords (NUMD): This field specifies the |
| | number of Dwords to transfer for this portion of the |
| | bitfile. This is a 0's based value. |

Firmware Image Download - Command Dword 11

| Bit | Description |
|---|---|
| 31:00 | Offset (OFST): This field specifies the number of Dwords |
| | offset from the start of the firmware image being downloaded |
| | to the controller. The offset is used to construct the complete |
| | firmware image when the firmware is downloaded in multiple |
| | pieces. The piece corresponding to the start of the firmware |
| | image typically has an Offset of 0h. |

A completion queue entry is posted to the Admin Completion Queue by controller 200 if a portion or all of the bitfile has been successfully provided to programming circuitry 120. Bitfile Download command specific status values are defined below:

FPGA Bitfile Download - Command Specific Status

| Values | Description |
|---|---|
| 14h | Overlapping Range: This error is indicated if the bitfile has |
| | overlapping ranges. This error is indicated if the granularity |
| | or alignment of the firmware image downloaded does not |
| | conform to the Firmware Update Granularity field indicated |

At block 406, in response to receiving the FPGA Bitfile Download command specific status value, indicating a successful configuration of programmable circuitry 206 in accordance with the bitfile, host processor 102 provides the FPGA Bitfile Commit command to controller 200 by submitting opcode 90h to an Admin Submission Queue. The Commit command is received by controller 200, where controller 200 causes activation of the configuration in accordance with the bitfile. When modifying an FPGA bitfile, the FPGA Bitfile Commit command verifies that a valid FPGA bitfile has been activated. Controller 200 may select a new bitfile to activate on a next Controller Level Reset as part of this command. The FPGA Bitfile Commit command is defined as follows, using the Command Dword 10 field:

| Bit | Description | |
|---|---|---|
| 31:06 | Reserved | |
| 05:03 | Commit Action (CA): This field specifies the action that | |
| | is taken on the bitfile downloaded with the FPGA Bitfile | |
| | Download command or on a previously downloaded and | |
| | placed bitfile. The actions are indicated in the following | |
| | table. Value | |
| | Value | Definition |
| | 000b | Downloaded bitfile replaces the current bitfile. |
| | | This bitfile is activated now. |
| | 001b | Downloaded bitfile replaces the current bitfile. |
| | | This bitfile is activated at the next reset. |
| | 010-111b | Reserved |

| | |
|---|---|
| 02:00 | Reserved |

A completion queue entry is posted by controller 200 to the Admin Completion Queue if programmable circuitry 206 has been successfully activated. Requests by host processor 102 that specify activation of a new FPGA bitfile at a next reset and return with status code value of 00h, any Controller Level Reset defined in NVMe Specifications 1.3 Section 7.3.2 activates the specified bitfile. FPGA Bitfile Commit command specific status values are defined below:

Firmware Commit - Command Specific Status Values

| Value | Description |
|---|---|
| 07h | Invalid FPGA Bitfile: The FPGA Bitfile specified for activation is invalid and |
| | not loaded by the controller. |
| 0Bh | FPGA Bitfile Activation Requires Conventional Reset: The bitfile commit was |
| | successful, however, activation of the bitfile requires a conventional reset. If an Function |
| | Level Reset (FLR) or controller reset occurs prior to a conventional reset, the controller |
| | shall continue operation with the currently executing bitfile. |
| 11h | Bitfile Activation Requires Reset: The bitfile commit was successful; however, the |
| | bitfile specified does not support being activated without a reset. The bitfile shall be |
| | activated at the next reset. |
| 13h | Bitfile Activation Prohibited: The image specified is being prohibited from activation by |
| | the controller for vendor specific reasons (e.g., controller does not support down revision |
| | firmware). |
| 14h | Overlapping Range: This error is indicated if the firmware image has overlapping |
| | ranges. |

At block 408, host processor 102 may receive one or more search parameters from the user via user interface 108, such as one or more digital images of a person or thing of interest, a location of interest, dates/times of interest, a desired processing time, geometric models, threshold values, etc. In one embodiment, host processor 102 selects an image-processing algorithm from host memory 104 based on the search parameters. For example, if the user requires review of a lengthy video stream (such as a five days) over a relatively short time period (such as 1/100 of the actual video footage or, in this case, seventy-two minutes), host processor 102 may select an algorithm that can review the video data in the time constraints given by the user. In this case, blocks 404 and 406 are implemented, configuring programmable circuitry 206 in accordance with the algorithm selected by host processor 102.

At block 410, host processor 102 stores at least some of the search parameters on I/O device 106, in memory 204, using storage commands as provided by the NVMe protocol.

At block 412, host processor 102 provides parameter location information to controller 200, identifying addresses in memory 204 where any stored parameter information is located. For example, in one embodiment, host processor 102 provides this address information in the form of a table, the table comprising starting address information and a corresponding file length (expressed, in one embodiment, as a number of LBA's) for each image file for consideration by programmable circuitry 206. Such a table is shown below:

TABLE 1
List of Pointers to List of Files

| | |
|---|---|
| Address of File 1 | #of LBAs for File 1 |
| Address of File 2 | #of LBAs for File 2 |
| . | |
| . | |
| . | |
| Address of File m | #of LBAs for File m |

In the table above, the address of each file may comprise a single memory address, or it could comprise a list of pointers and corresponding memory lengths when a file is not stored on memory 204 in a contiguous manner. For example, each image file stored in memory 204 may be described by the following table of pointers:

TABLE 2
List of Pointers to Contiguous LBAs in a File

| | |
|---|---|
| Address of the beginning location of the 1^{st} | #of contiguous LBAs |
| contiguous block of LBAs in the file | |
| Address of the beginning location of the 2^{nd} | #of contiguous LBAs |
| contiguous block of LBAs in the file | |
| . | |
| . | |
| . | |
| Address of the beginning location of the last | #of contiguous LBAs |
| contiguous block of LBAs in the file | |

As shown, the table comprises a number of entries, each entry defining a beginning address in memory 204 and a corresponding number of contiguous Logical Block Addresses (LBAs) that define where in memory 204 a file is located.

The information in table 1 is provided by host processor 102 to controller 200 using a custom, vendor specific command (referred to herein as “Load A command”) as allowed by the NVMe protocol, shown below:

Load A command structure

| | | | | | | | | | | | | | | | |
|---|---|---|---|---|---|---|---|---|---|---|---|---|---|---|---|
| Dword | B31 | B30 | B29 | B28 | B27 | B26 | B25 | B24 | B23 | B22 | B21 | B20 | B19 | B18 | B17 |

| 0 | COMMAND IDENTIFIER | |
|---|---|---|
| 1 | NAME SPACE IDENTIFIER | |
| 2 | RESERVED | |
| 3 | | |
| 4 | METADATA POINTER | |
| 5 | | |
| 6 | PRP ENTRY 1 | |
| 7 | | |
| 8 | PRP ENTRY 2 | |
| 9 | | |
| 10 | NUMBER OF DWORDS IN DATA TRANSFER | |
| 11 | NUMBER OF DWORDS IN METADATA TRANSFER | |
| 12 | RESERVED | |
| 13 | NUMBER OF ENTRIES IN Table 1 | RESERVED |

| 14 | ADDRESS OF Table 1 | | | | | | | | | | | | | | | | | |
|---|---|---|---|---|---|---|---|---|---|---|---|---|---|---|---|---|---|---|
| 15 | | | | | | | | | | | | | | | | | | |
| | Dword | B16 | B15 | B14 | B13 | B12 | B11 | B10 | B9 | B8 | B7 | B6 | B5 | B4 | B3 | B2 | B1 | B0 |

| | | | | | | | | |
|---|---|---|---|---|---|---|---|---|
| 0 | PS DT | 0 | 0 | 0 | 0 | 0 | 0 | COMMAND OPCODE |

| | |
|---|---|
| 1 | NAME SPACE IDENTIFIER |
| 2 | RESERVED |
| 3 | |
| 4 | METADATA POINTER |
| 5 | |
| 6 | PRP ENTRY 1 |
| 7 | |
| 8 | PRP ENTRY 2 |
| 9 | |
| 10 | NUMBER OF DWORDS IN DATA TRANSFER |
| 11 | NUMBER OF DWORDS IN METADATA TRANSFER |
| 12 | RESERVED |
| 13 | RESERVED |
| 14 | ADDRESS OF Table 1 |
| 15 | |

Where:

Dword0: Bits 15 & 14: PRP or SGL (00 means PGP)
Bits 9 & 8: 00: Normal Operation

Dword 14-15: 64-bit pointer

Dword 13: Specifies the number of entries in table 1, which represents the number of image files to be analyzed by programmable circuitry 206.

At block 414, information is provided by host processor 102 to controller 200, identifying a starting address in memory 204 and number of LBA's associated with a video file to be processed by programmable circuitry 206. This information is shown in the format of Table 2, discussed above, typically comprising a linked-list of LBAs that identify wherein in memory 204 the video file is stored. Each entry in Table 2 comprises a starting address in memory 204, each starting address having a corresponding LBA length associated therewith. The pointer information in Table 2 is provided from host processor 102 to controller 200 using a second custom, vendor specific command (referred to herein as “Load B command”) as allowed by the NVMe protocol, shown below:

Load B command structure

| | | | | | | | | | | | | | | | |
|---|---|---|---|---|---|---|---|---|---|---|---|---|---|---|---|
| Dword | B31 | B30 | B29 | B28 | B27 | B26 | B25 | B24 | B23 | B22 | B21 | B20 | B19 | B18 | B17 |

| 0 | COMMAND IDENTIFIER | |
|---|---|---|
| 1 | NAME SPACE IDENTIFIER | |
| 2 | RESERVED | |
| 3 | | |
| 4 | METADATA POINTER | |
| 5 | | |
| 6 | PRP ENTRY 1 | |
| 7 | | |
| 8 | PRP ENTRY 2 | |
| 9 | | |
| 10 | NUMBER OF DWORDS IN DATA TRANSFER | |
| 11 | NUMBER OF DWORDS IN METADATA TRANSFER | |
| 12 | RESERVED | |
| 13 | NUMBER OF ENTRIES IN TABLE 2 | RESERVED |

| 14 | STARTING ADDRESS OF 1^{ST} ENTRY IN TABLE 2 | | | | | | | | | | | | | | | | | |
|---|---|---|---|---|---|---|---|---|---|---|---|---|---|---|---|---|---|---|
| 15 | | | | | | | | | | | | | | | | | | |
| | Dword | B16 | B15 | B14 | B13 | B12 | B11 | B10 | B9 | B8 | B7 | B6 | B5 | B4 | B3 | B2 | B1 | B0 |

| | | | | | | | | |
|---|---|---|---|---|---|---|---|---|
| 0 | PS DT | 0 | 0 | 0 | 0 | 0 | 0 | COMMAND OPCODE |

| | |
|---|---|
| 1 | NAME SPACE IDENTIFIER |
| 2 | RESERVED |
| 3 | |
| 4 | METADATA POINTER |
| 5 | |
| 6 | PRP ENTRY 1 |
| 7 | |
| 8 | PRP ENTRY 2 |
| 9 | |
| 10 | NUMBER OF DWORDS IN DATA TRANSFER |
| 11 | NUMBER OF DWORDS IN METADATA TRANSFER |
| 12 | RESERVED |
| 13 | RESERVED |
| 14 | STARTING ADDRESS OF 1^{ST} ENTRY IN TABLE 2 |
| 15 | |

This command allows programmable circuitry 206 find a large video file stored in memory 204. The video file may contain video footage taken by a digital camera over a period of many hours or days. In this example, the top 8 bits of Dword 13 denote a number of pointers as shown in Table 2 describing fragments of the video file as they are stored in memory 204. Dwords 14 and 15 are used to denote a starting address of the location of the first pointer in Table 2. In other embodiments, the pointers may be referenced by a greater or fewer number of bits in Dword 13, or in a different Dword.

At block 416, after the address location of the one or more image files have been provided from host processor 102 to controller 200 via one or more Load A commands, and an address of one or more comparison files (i.e., video files) have been provided by host processor 102 to controller 200 via one or more Load B commands, processor 102 may initiate processing by sending a custom, vendor specific GO command, instructing controller 200 to initiate processing using programmable circuitry 206, as follows:

GO command structure

| | | | | | | | | | | | | | | | |
|---|---|---|---|---|---|---|---|---|---|---|---|---|---|---|---|
| Dword | B31 | B30 | B29 | B28 | B27 | B26 | B25 | B24 | B23 | B22 | B21 | B20 | B19 | B18 | B17 |

| 0 | COMMAND IDENTIFIER | | | | | | | | | | | | | | | | | |
|---|---|---|---|---|---|---|---|---|---|---|---|---|---|---|---|---|---|---|
| 1 | NAME SPACE IDENTIFIER | | | | | | | | | | | | | | | | | |
| 2 | RESERVED | | | | | | | | | | | | | | | | | |
| 3 | | | | | | | | | | | | | | | | | | |
| 4 | METADATA POINTER | | | | | | | | | | | | | | | | | |
| 5 | | | | | | | | | | | | | | | | | | |
| 6 | PRP ENTRY 1 | | | | | | | | | | | | | | | | | |
| 7 | | | | | | | | | | | | | | | | | | |
| 8 | PRP ENTRY 2 | | | | | | | | | | | | | | | | | |
| 9 | | | | | | | | | | | | | | | | | | |
| 10 | NUMBER OF DWORDS IN DATA TRANSFER | | | | | | | | | | | | | | | | | |
| 11 | NUMBER OF DWORDS IN METADATA TRANSFER | | | | | | | | | | | | | | | | | |
| 12 | | | | | | | | | | | | | | | | | | |
| 13 | | | | | | | | | | | | | | | | | | |
| 14 | | | | | | | | | | | | | | | | | | |
| 15 | | | | | | | | | | | | | | | | | | |
| | Dword | B16 | B15 | B14 | B13 | B12 | B11 | B10 | B9 | B8 | B7 | B6 | B5 | B4 | B3 | B2 | B1 | B0 |

| | | | | | | | | |
|---|---|---|---|---|---|---|---|---|
| 0 | PS DT | 0 | 0 | 0 | 0 | 0 | 0 | COMMAND OPCODE |

| | |
|---|---|
| 1 | NAME SPACE IDENTIFIER |
| 2 | RESERVED |
| 3 | |
| 4 | METADATA POINTER |
| 5 | |
| 6 | PRP ENTRY 1 |
| 7 | |
| 8 | PRP ENTRY 2 |
| 9 | |
| 10 | NUMBER OF DWORDS IN DATA TRANSFER |
| 11 | NUMBER OF DWORDS IN METADATA TRANSFER |
| 12 | |
| 13 | |
| 14 | |
| 15 | |

The opcode could be defined as any hexadecimal number, such as 92h. In this example, Dwords 6 and 7 in this command (PGP Entry 1) point to the location where the results received from processing by programmable circuitry 206 are to be stored. In response to receiving the GO command, controller 200 instructs programmable circuitry 206 to perform a comparison of each image file that was identified at block 412 with the video file identified at block 414. In this example, programmable circuitry 206 then compares the image file(s) to the video file to determine whether a match of the image file is found in the video file. Of course, depending on how programmable circuitry was configured in blocks 404 and 406, one of any number of different processing may be performed by programmable circuitry 206. In one embodiment, one image file is compared with one video file each time a GO command is issued, while in another embodiment, all image files identified in Table 1 is compared against one or more video files identified in Table 2.

At block 418, controller 200 receives a result of each comparison by programmable circuitry 206, i.e., whether an image being compared to the video file was found in the video file. Other information may be provided to controller 200 from programmable circuitry 206 as well, such as time information when in the video the compared image was found, an identification of an area being monitored by the video file, a video clip of the video file at the time the match was determined, etc. Controller 200, in turn, provides the information to one of the completion queues, where it is read by host processor 102.

At block 420, a result of the processing is provided from host processor 102 to user interface 108. The result may comprise one or more video clips containing a match to the search parameters provided by the user in block 406. For example, if one the search parameters was a digital image of a suspect's face, the result may comprise one or more 30-second video clips of the evaluated video data each time that a match was found between the suspect's face and people in the video file.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

It is to be understood that the decoding apparatus and methods described herein may also be used in other communication situations and are not limited to RAID storage. For example, compact disk technology also uses erasure and error-correcting codes to handle the problem of scratched disks and would benefit from the use of the techniques described herein. As another example, satellite systems may use erasure codes in order to trade off power requirements for transmission, purposefully allowing for more errors by reducing power and chain reaction coding would be useful in that application. Also, erasure codes may be used in wired and wireless communication networks, such as mobile telephone/data networks, local-area networks, or the Internet. Embodiments of the current invention may, therefore, prove useful in other applications such as the above examples, where codes are used to handle the problems of potentially lossy or erroneous data.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A configurable I/O device, comprising:
a controller for performing a first function related to the I/O device in response to receiving instructions from a host processor over a data bus in accordance with a data storage and retrieval protocol;
a memory coupled to the controller for storing data received from the controller; and
programmable circuitry coupled to the controller for performing a second function unrelated to data storage and retrieval in response to second instructions received by the controller from the host processor over the data bus in accordance with the data storage and retrieval protocol.

2. The configurable I/O device of claim 1, wherein the controller is configured to receive programming instructions from the host processor over the data bus in accordance with the data storage and retrieval protocol and, in response to receiving the programming instructions, configuring the programmable circuitry to perform the second function.

3. The configurable I/O device of claim 1, wherein the data bus comprises a PCIe bus, and the first and second instructions comprise instructions in accordance with a NVMe protocol.

4. The configurable I/O device of claim 1, wherein the second instructions comprise:
a first command identifying a location in the memory where one or more search parameters are stored;
a second command identifying a location in the memory where a video file is stored; and
a third command for initiating an analysis of the video file in accordance with the parameters.

5. The configurable I/O device of claim 4, wherein the one or more search parameters comprise an image file and the analysis comprises determining whether an image represented by the image file is present in a video represented by the video file.

6. The configurable I/O device of claim 4, wherein the search parameters comprise one or more geometric models and threshold values.

7. The configurable I/O device of claim 1, wherein the programmable circuitry comprises an embedded FPGA.

8. The configurable I/O device of claim 1, wherein the programmable circuitry comprises an embedded video processor comprising a matrix of convolutional neural networks and digital signal processors.

9. The configurable I/O device of claim 4, wherein the second command comprises a linked-list of LBAs that identify wherein in the memory the video file is stored.

10. A computer system for high-throughput data processing, comprising:
a host processor; and
an I/O device electronically coupled to the host processor by a data bus, the I/O device comprising:
a controller for performing a first function related to the I/O device in response to receiving instructions from a host processor over the data bus in accordance with a data storage and retrieval protocol; and
programmable circuitry for performing a function unrelated to data storage and retrieval in response to second instructions received by the controller from the host processor over the data bus in accordance with the data storage and retrieval protocol.

11. The computer system of claim 10, wherein the controller is configured to receive programming instructions from the host processor over the data bus in accordance with the data storage and retrieval protocol and, in response to receiving the programming instructions, configure the programmable circuitry to perform the second function.

12. The computer system of claim 10, wherein the data bus comprises a PCIe bus, and the first and second instructions comprise instructions in accordance with a NVMe protocol.

13. The computer system of claim 10, wherein the second instructions comprise:
a first command identifying a location in the memory where one or more search parameters are stored;
a second command identifying a location in the memory where a video file is stored; and
a third command for initiating an analysis of the video file in accordance with the parameters.

14. The computer system of claim 13, wherein the one or more search parameters comprise an image file and the analysis comprises determining whether an image represented by the image file is present in a video represented by the video file.

15. The computer system of claim 13, wherein the search parameters comprise one or more geometric models and threshold values.

16. The computer system of claim 10, wherein the programmable circuitry comprises an embedded FPGA.

17. The computer system of claim 10, wherein the programmable circuitry comprises an embedded video processor comprising a matrix of convolutional neural networks and digital signal processors.

18. The computer system of claim 13, wherein the second command comprises a linked-list of LBAs that identify wherein in the memory the video file is stored.

19. A method for performing high data throughput computations, comprising:
storing data in a memory of an I/O device by a host processor using a data storage and retrieval protocol, the I/O device coupled to the host processor via a data bus;
configuring programmable circuitry located within the I/O device by the host processor using the data storage and retrieval protocol; and
causing, by the host processor, the programmable circuitry to initiate the high data throughput computations using the data storage and retrieval protocol.

20. The method of claim 19, wherein storing data on the I/O device comprises storing an image file and a video file in the memory, and the method further comprises:
providing, by the host processor to the programmable circuitry, image location information of an address in the memory of the image file using the data storage and retrieval protocol; and
providing, by the host processor to the programmable circuitry, video file location information of an address in the memory of the video file using the data storage and retrieval protocol;
wherein the high data throughput computations comprise identifying an image represented by the image file in a video represented by the video file.
